(19) United States
(12) Patent Application Publication
(10) Pub. No.: US 2025/0018548 A1
(43) Pub. Date: Jan. 16, 2025

(54) POWER TOOL

(71) Applicant: JIANGSU DONGCHENG TOOLS TECHNOLOGY CO., LTD., NANTONG (CN)

(72) Inventors: Aiguo LIU, NANTONG (CN); Yuhao ZHANG, NANTONG (CN)

(73) Assignee: JIANGSU DONGCHENG TOOLS TECHNOLOGY CO., LTD., NANTONG (CN)

(21) Appl. No.: 18/898,741

(22) Filed: Sep. 27, 2024

Related U.S. Application Data
(63) Continuation of application No. PCT/CN2023/122514, filed on Sep. 28, 2023.

(30) Foreign Application Priority Data
Sep. 30, 2022 (CN) 202211208058.6

(51) Int. Cl. B25F 5/00; B24B 23/02

(52) U.S. Cl. CPC B25F 5/008; B24B 23/028

(57) ABSTRACT

A power tool, including: a housing, extending in a longitudinal direction; and a fan, a motor, and a circuit board that are received in the housing. The housing defines an air outlet, a first air inlet, and a second air inlet. The first air inlet is adjacent to the motor, and the second air inlet is adjacent to the circuit board; the first air inlet is disposed between the air outlet and the second air inlet. The power tool includes a first heat dissipation air path that flows through the motor and a second heat dissipation air path that flows through the circuit board. The motor includes an output shaft extending along the longitudinal direction. The output shaft is connected to the fan; the air outlet, the fan, the first air inlet, and the second air inlet are arranged sequentially in an axis direction of the output shaft.

### CROSS REFERENCE

The present application is a continuation-application of International (PCT) Patent Application No. PCT/CN2023/122514, filed on Sep. 28, 2023, which claims priority of Chinese Patent Application No. 202211208058.6, filed on Sep. 30, 2022, the entire contents of which are hereby incorporated by reference in its entirety.

### TECHNICAL FIELD

The present disclosure relates to the technical field of power tools, and in particular to a power tool.

### BACKGROUND

Existing power tools, especially lithium battery-powered power tools, are required to strictly deal with catching fires or reduced life of lithium batteries due to overcharging and over-discharging and thus are arranged with circuit boards to detect and protect the state of battery packs. The circuit board will heat up during use due to high loads and may fail when the heat is too great, which in turn affects the monitoring of the battery, causing abnormal conditions such as over-discharging of the battery and ultimately leading to a reduction in the life of the battery pack or damage to a motor.

Some existing technical solutions in response thereto are to apply a fan arranged inside the power tool to fan the airflow to cool the circuit board, and the airflow first passes through the circuit board and then through the motor, which may complete the heat dissipation for both the circuit board and the motor. However, since the airflow successively passes through multiple heat-generating components, the cooling efficiency is low, such that the heat dissipation effect is poor. In addition, the motor and the circuit board share a common cooling duct, and the temperature rise of any one of the components will directly affect the other, which in turn worsens the temperature rise of the component required to be cooled.

In view of this, there is a real need to provide an improved power tool to overcome the deficiencies in the related art.

### SUMMARY OF THE DISCLOSURE

The technical solution adopted by the present disclosure is as followed.

A power tool, including: a housing, extending in a longitudinal direction; and a fan, a motor, and a circuit board that are received in the housing; wherein the housing defines an air outlet, a first air inlet, and a second air inlet; wherein the first air inlet is adjacent to the motor, and the second air inlet is adjacent to the circuit board; the first air inlet is disposed between the air outlet and the second air inlet; the power tool includes a first heat dissipation air path that flows through the motor and a second heat dissipation air path that flows through the circuit board, formed by a rotation of the fan; wherein the housing includes: a main part, receiving the motor; and a holding part, connected to a rear side of the main part in a longitudinal direction; wherein an output shaft of the motor extends in the longitudinal direction, and the first air inlet is disposed on a front side of the holding part in the longitudinal direction.

### BRIEF DESCRIPTION OF THE DRAWINGS

Specific embodiments of the present disclosure are described in further detail below in conjunction with the accompanying drawings.

FIG. 1 is an internal view of a power tool according to some embodiments of the present disclosure.

FIG. 2 is a cross-sectional view of a power tool according to some embodiments of the present disclosure.

FIG. 3 is a cross-sectional view of a power tool according to other embodiments of the present disclosure.

### DETAILED DESCRIPTION

Terms used in the present disclosure are intended only for the purpose of describing particular embodiments and are not to limit the present disclosure. For example, the following terms such as “up”, “down”, “front”, “back”, etc., which indicate orientation or positional relationships, are only based on the orientation or positional relationship shown in the accompanying drawings, and intended only for the purpose of facilitating and simplifying the description of the present disclosure, but not intended to indicate or imply that a device/component referred to must have a particular orientation or be constructed and operated in a particular orientation, and therefore cannot be construed as a limitation of the present disclosure.

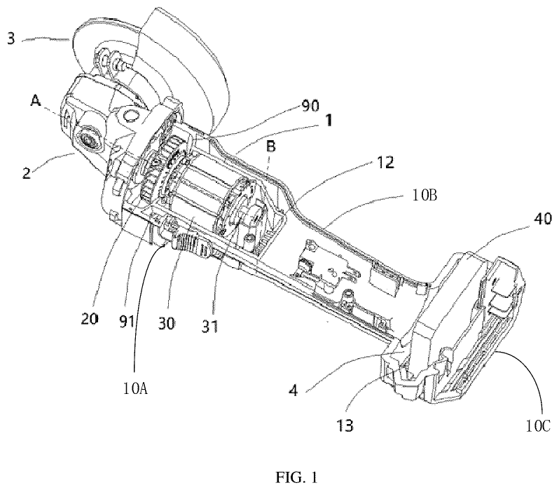

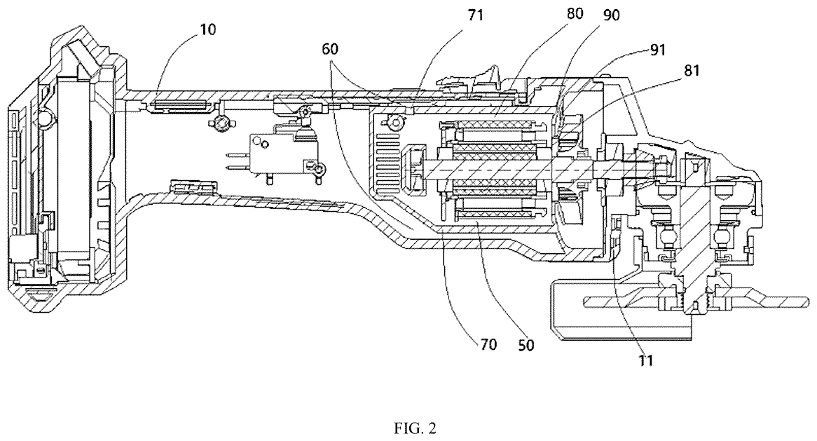

Referring to FIGS. 1 and 2, some embodiments of the present disclosure relate to a power tool for grinding, drilling, cutting, etc. of a workpiece or a work surface under electric drive, including a housing 10, a fan 20, a motor 30, and a circuit board 40. The housing 10 extends in a longitudinal direction A (and accordingly, a transverse direction is indicated as B) and the circuit board 40, the fan 20, and the motor 30 are disposed inside the housing 10. The housing 10 defines an air outlet 11, a first air inlet 12, and a second air inlet 13. The circuit board 40 is configured to control an operation of functional components including the motor 30. The fan 20 is configured to generate an airflow inside the housing 10 for heat exchange to reduce the temperature of structures through which the airflow passes, in particular to keep the temperature of the motor 30 and the circuit board 40 below a tolerable temperature.

In the embodiments, the air outlet 11 is configured to discharge the airflow from the housing 10 to an outside, and each of the first air inlet 12 and the second air inlet 13 is configured to introduce the airflow from the outside to the housing 10; the first air inlet 12 is adjacent to the motor 30, and the second air inlet 13 is adjacent to the circuit board 40, such that the introduced airflow blows directly on the motor 30 and the circuit board 40, and thus the cooling efficiency may be improved. In addition, the first air inlet 12 is disposed between the air outlet 11 and the second air inlet 13; the airflow discharged from the air outlet 11 out of the housing 10 is introduced through the first air inlet 12 and the second air inlet 13, respectively; and the airflow introduced through the first air inlet 12 is directly discharged out of the housing 10 from the air outlet 11 without passing through the circuit board 40, after heat exchange with the motor 30, thereby avoiding the circuit board 40 from affected by the temperature rise of the motor 30, so as to strengthen the protection of the circuit board 40. In some embodiments, the housing 10 includes a main part 10A that receives the motor 30, a holding part 10B that extends backward in the longitudinal direction from the main part 10A, and a base part 10C that is disposed at a rear end of the holding part 10B in the longitudinal direction, where the circuit board 40 is received in the base part 10C, and the second air inlet 13 is defined on the base part 10C and faces the circuit board 40.

In order to minimize interference between the temperature rise of the circuit board 40 and the motor 30, the power tool further includes a first heat dissipation air path 50 that flows through the motor 30 and a second heat dissipation air path 60 that flows through the circuit board 40, formed by a rotation of the fan 20, where the second heat dissipation air path 60 does not flow through the motor 30, and the first heat dissipation air path 50 does not flow through the circuit board 40. Because the first air inlet 12 is closer to the air outlet 11 than the second air inlet 13, the path length of the first heat dissipation air path 50 is shorter than the path length of the second heat dissipation air path 60. Under the vacuum effect of the fan 20, the air volume of the first heat dissipation air path is greater, which has a correspondingly stronger heat dissipation effect on the motor 30 that has a greater heat generation, thereby optimizing the heat dissipation efficiency of the whole machine.

The power tool further includes an operating assembly 3 and a transmission assembly 2, where the operating assembly 3 is configured for grinding, drilling, cutting, etc. directly on the workpiece or thee work surface, and the transmission assembly 2 is configured to transfer a kinetic energy output from the motor 30 to the operating assembly 3. The motor 30 includes an output shaft 31 extending along the longitudinal direction; the output shaft 31 of the motor 30 is connected to the transmission assembly 2 and configured to drive the operating assembly 3 through the transmission assembly 2, and the fan 20 is connected to the output shaft 31 and rotatable along with a rotation of the output shaft 31. The air outlet 11, the fan 20, the first air inlet 12, and the second air inlet 13 are arranged sequentially in an axis direction of the output shaft 31, and in the embodiments as illustrated, are also arranged sequentially back and forth in the axial direction of the power tool. The airflow flows in a generally straight direction within the housing 10 to reduce airflow resistance and minimize noise, where the first heat dissipation air path 50 and the second heat dissipation air path 60 have or may have a local bending angle of no more than 45°, such that the deflection angle of the flow direction of the airflow is kept within a small range.

The power tool has a lateral direction perpendicular to the axis direction of the output shaft 31, and in some embodiments, a part of the housing 10 facing an outer side of the motor 30 is in the lateral direction, where the first air inlet 12 is defined on the part of the housing 10. The fan 20 is disposed on a side of the output shaft 31 of the motor 30, i.e., on a front side, and acts as a vacuum source to generate the airflow; the air outlet 11 is disposed on the same side of the motor 30 as the fan 20, while the first air inlet 12 is correspondingly disposed on the other side of the output shaft 31 of the motor 30, i.e., on a rear side. In this way, the airflow entering the first air inlet 12 passes through a main body portion of the motor 30, in particular between a stator and a rotor of the motor 30, so as to intensify the cooling effect. Specifically, the first air inlet 12 is disposed directly facing an area on the rear side of the motor 30 or facing a rear structure of the motor 30, such as facing a rear bearing of the motor 30, such that the first air inlet 12 is adjacent to the motor 30. In the embodiments, in order to facilitate the conversion of the airflow introduced in the lateral direction to flow in the axial direction, the first air inlet 12 may be arranged with multiple fins (not shown), which are bent toward the motor 30.

The heat dissipation air path, serving as an airflow path, is formed by an air duct construction enclosed by the housing 10 and internal structural members within the housing 10, which is configured to, but not limited to, for the airflow to flow. The air duct may be arranged with components that do not completely block the airflow within the air duct, such as wires and switching components, and the like.

The power tool includes at least two disconnected air ducts for passing the first heat dissipation air path 50 and the second heat dissipation air path 60, respectively, such that the first heat dissipation air path 50 and the second heat dissipation air path 60 are independently disposed of each other. Different temperature airflows can flow between the independently disposed heat dissipation air paths, to reduce and exclude heat exchange between the airflows. The first heat dissipation air path 50 passes through the first air inlet 12 and the motor 30 to the air outlet 11 in turn, and the second heat dissipation air path 60 passes through the second air inlet 13 and the circuit board 40 to the air outlet 11 in turn.

The power tool further includes a partition 70 separating the first heat dissipation air path 50 and the second heat dissipation air path 60, the partition 70 being disposed within the housing 10; where at least a part of the partition 70 is disposed around the motor 30. By providing the partition 70 separating the first heat dissipation air path 50 and the second heat dissipation air path 60, the motor 30 and the circuit board 40 are protected by providing the heat dissipation air paths independently of each other in different contexts, including: the motor 30 is not subject to the heat generated by the circuit board 40, in particular the partition 70 may be made of a heat-insulating material; the circuit board 40 is not subject to the heat generated by the motor 30, in particular the partition 70 may be made of a heat-insulating material; the heated airflow after cooling the circuit board 40 does not pass through the motor 30 and reduce the cooling efficiency of the motor 30; the heated airflow after cooling the motor 30 does not pass through the circuit board 40 and reduce the cooling efficiency of the circuit board 40; and when the circuit board 40 is not as heat-resistant as the motor 30, the circuit board 40 does not fail due to the continuous operation of the motor 30.

In different embodiments, the partition 70, as an internal structural member of the power tool, may be provided in a variety of shapes, including a flat plate and a curved member, and different parts of the partition 70 may be curved or flat. In some embodiments, at least a part of the partition 70 has a shape in correspondence with the shape of the housing 10, such that a regular through air duct is formed between the housing 10 and the part of the partition 70. When the partition 70 is disposed between the motor 30 and the housing 10, the first heat dissipation air path 50 is formed between the partition 70 and the motor 30, and the airflow of the first heat dissipation air path 50 cools the motor 30; the second heat dissipation air path 60 is formed between the partition 70 and the housing 10, and the airflow of the second heat dissipation air path 60 passes through without heat exchange.

The partition 70 may define a through hole 71 for a wire to pass through. In order not to reduce the ability of the partition 70 to separate the air paths, a resilient member or felt is arranged in the through hole 71, where the resilient member may be a rubber sheet. After the wire passes through the through hole 71, the resilient member springs back or the felt blocks the remaining space of the through hole 71, such that the airflow does not pass through the through hole 71 or passes through the through hole 71 to a small extent.

The partition 70 and the housing 10 together enclose to define a cooling cavity 80, the cooling cavity 80 having a relatively sealed internal space to reduce heat exchange with the outside of the cavity. The motor 30 is disposed in the cooling cavity 80, a side of the cooling cavity 80 with the motor 30 defines an opening 81 toward the fan 20, and the first air inlet 12 is defined on the other side of the cooling cavity 80 opposite to the motor 30 and is in communication with the cooling cavity. The airflow enters the cooling cavity 80 from the first air inlet 12 and flows toward the opening 81, and cools the motor 30 as it flows through the motor 30.

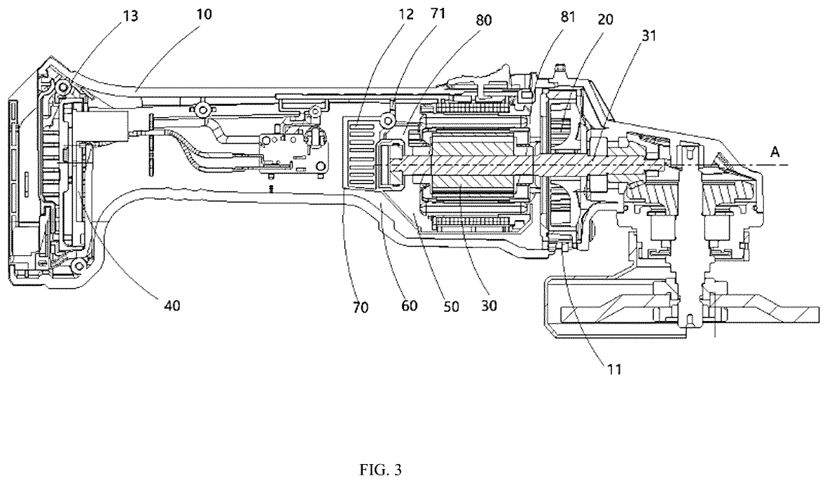

The cooling cavity 80 is arranged around the motor 30 and isolates other parts of the power tool, such that the motor 30, which is the main heat source, is less likely to affect other parts, such as to the circuit board 40, a switching component, a sensor, a screen interface, etc. The opening 81 toward the fan 20 keeps the temperature in the cooling cavity 80 at a low level during normal operation of the fan 20, while even if the fan 20 operates abnormally causing the temperature in the cooling cavity 80 to rise to a high level, the closure of the cavity ensures that the other parts are not subject to damage caused by the abnormal temperature rise. Referring to FIG. 3, in other embodiments, the partition 70 is less arranged around the motor 30, and an external switch interface and a screen interface at the top of the housing 10 are disposed on an inside of the cooling cavity 80. In FIG. 3, it is further noted that the air outlet 11 is disposed on a side of the fan 20 perpendicular to the longitudinal direction, whereas the air outlet 11 in FIG. 2 is disposed on a side of the fan 20 in the longitudinal direction.

An end of the cooling cavity 80 with the opening 81 is arranged with a deflector plate 90, and the opening 81 is defined on a middle part of the deflector plate 90. The deflector plate 90 defines multiple vents 91 around the opening 81, and the vents 91 are not in communication with the opening 81 but are in communication with the second heat dissipation air path 60. That is, the first heat dissipation air path 50 passes through the first air inlet 12, the motor 30, and the opening 81 sequentially to the air outlet 11, and the second heat dissipation air path 60 passes through the second air inlet 13, the circuit board 40 and the vents 91 sequentially to the air outlet 11.

In some embodiments, the power tool is an angle grinder. The angle grinder includes the housing 10, a drive assembly 1, the transmission assembly 2, the operating assembly 3, and a control assembly 4. The drive assembly 1 includes the motor 30 and the output shaft 31, and the output shaft 31 is transmission-connected to the transmission assembly 2. A side of the transmission assembly 2 opposite to the output shaft 31 is connected to the operating assembly 3, the operating assembly 3 including a grinding wheel, a wire wheel, etc. The motor 30 is configured to drive the operating assembly 3 through the transmission assembly 2 to act on a work surface to be operated or a workpiece to be processed, in order to realize the operation of the power tool. The control assembly 4 includes the circuit board 40 and is configured to control the operation of the drive assembly 1. The drive assembly 1, the transmission assembly 2, and the control assembly 4 are arranged in the housing 10 of the power tool, and are positionally constrained and protected by the housing 10. A handle and an external switch may be arranged on an outside of the housing 10, and the housing 10 may be connected to a battery pack.

In some embodiments, the power tool is a straight angle grinder.

The present disclosure has the following beneficial effects compared to the related art: the first air inlet of the power tool is adjacent to the motor, the second air inlet is adjacent to the circuit board, and the first air inlet is located between the air outlet and the second air inlet; the power tool includes a first heat dissipation air path that flows through the motor and a second heat dissipation air path that flows through the circuit board, formed by a rotation of the fan. Multiple heat dissipation air paths, formed by the rotation of the fan, in the housing flow through the motor and the circuit board, respectively, cooling the motor and the circuit board adjacent to the respective air inlet, thereby improving the cooling efficiency and reducing the interference of the temperature rise with each other. The first air inlet adjacent to the motor is located between the second air inlet adjacent to the circuit board and the air outlet which discharges airflow to the outside world, avoiding the circuit board from being affected by the temperature rise of the airflow flowing through the motor, further protecting the circuit board, and the path of the first heat dissipation air circuit is shorter to strengthen the heat dissipation effect of the motor.

Further, the first air inlet is arranged on the longitudinal front side of the holding part, such that when the user grasps the holding part with his/her hand and operates the power tool, the dust and debris generated by the operating components in the operating process will splash the user's hand, and the dust and debris will rebound outward under the blockage of the hand and not be easily sucked into the interior of the housing from the first air inlet, thereby effectively preventing the dust and debris from damaging the motor.

The present disclosure is not limited to the above specific embodiments. Those skilled in the art can easily understand that there are many alternatives to the power tool of the present disclosure without departing from the principles and scope of the present disclosure. The scope of the present disclosure is subject to the contents of the claims.

What is claimed is:

1. A power tool, comprising: a housing, extending in a longitudinal direction; and a fan, a motor, and a circuit board that are received in the housing; wherein the housing defines an air outlet, a first air inlet, and a second air inlet; wherein the first air inlet is adjacent to the motor, and the second air inlet is adjacent to the circuit board; the first air inlet is disposed between the air outlet and the second air inlet; the power tool comprises a first heat dissipation air path that flows through the motor and a second heat dissipation air path that flows through the circuit board, formed by a rotation of the fan;
wherein the housing comprises:
a main part, receiving the motor; and
a holding part, connected to a rear side of the main part in the longitudinal direction;
wherein an output shaft of the motor extends in the longitudinal direction, and the first air inlet is disposed on a front side of the holding part in the longitudinal direction.

2. The power tool according to claim 1, wherein the first air inlet is disposed on a rear side of the motor in the longitudinal direction.

3. The power tool according to claim 1, wherein a diameter of the main part is greater than a diameter of the holding part; the housing comprises a transition portion connecting the main part to the holding part, and the first air inlet is defined on the transition portion.

4. The power tool according to claim 1, wherein the housing further comprises a base part that is disposed at a rear end of the holding part in the longitudinal direction; the circuit board is received in the base part, and the second air inlet is defined on the base part and faces the circuit board; the second air inlet is disposed opposite to the first air inlet in the longitudinal direction.

5. The power tool according to claim 1, wherein the output shaft is connected to the fan and configured to drive the fan to rotate; the air outlet, the fan, the first air inlet, and the second air inlet are arranged sequentially in an axis direction of the output shaft.

6. The power tool according to claim 5, wherein the power tool has a lateral direction perpendicular to the axis direction of the output shaft, and the first air inlet is defined on a part of the housing facing an outer side of the motor in the lateral direction.

7. The power tool according to claim 1, wherein the first heat dissipation air path passes through the first air inlet and the motor sequentially to the air outlet, and the second heat dissipation air path passes through the second air inlet and the circuit board sequentially to the air outlet; the first heat dissipation air path and the second heat dissipation air path are independently disposed of each other.

8. The power tool according to claim 7, further comprising a partition separating the first heat dissipation air path and the second heat dissipation air path; wherein the partition is disposed within the housing, and at least a part of the partition is disposed around the motor.

9. The power tool according to claim 8, wherein the partition is disposed between the motor and the housing, the first heat dissipation air path is formed between the partition and the motor, and the second heat dissipation air path is formed between the partition and the housing.

10. The power tool according to claim 8, wherein the partition defines a through hole for a wire to pass through, and a resilient member or felt is arranged in the through hole.

11. The power tool according to claim 8, wherein the partition and the housing together enclose to define a cooling cavity; the motor is disposed in the cooling cavity, a side of the cooling cavity with the motor defines an opening toward the fan, and the first air inlet is defined on another side of the cooling cavity opposite to the motor and is in communication with the cooling cavity.

12. The power tool according to claim 11, wherein an end of the cooling cavity with the opening is arranged with a deflector plate, and the opening is defined on a middle part of the deflector plate; the deflector plate defines a plurality of vents around the opening; the second heat dissipation air path passes through the second air inlet, the circuit board, and the plurality of vents sequentially to the air outlet.

13. The power tool according to claim 1, wherein the first heat dissipation air path and the second heat dissipation air path each have a local bending angle of no more than 45°.

14. The power tool according to claim 1, wherein the first air inlet is disposed directly facing an area on a rear side or a rear structure of the motor.

15. The power tool according to claim 8, wherein at least a part of the partition has a shape in correspondence with a shape of the housing.

16. The power tool according to claim 11, wherein an external switch interface and a screen interface at a top of the housing are disposed on an inside of the cooling cavity.

17. The power tool according to claim 1, wherein the power tool is an angle grinder, comprising: the housing, a drive assembly, a transmission assembly, an operating assembly, and a control assembly;
wherein the drive assembly comprises the motor, and an output shaft of the motor is transmission-connected to the transmission assembly; a side of the transmission assembly opposite to the output shaft is connected to the operating assembly; the motor is configured to drive the operating assembly through the transmission assembly to act on a work surface to be operated or a workpiece to be processed;
the control assembly comprises the circuit board and is configured to control an operation of the drive assembly;
the drive assembly, the transmission assembly, and the control assembly are arranged in the housing of the power tool.

18. A power tool, comprising: a housing, extending in a longitudinal direction; and a fan, a motor, and a circuit board that are received in the housing; wherein the housing defines an air outlet, a first air inlet, and a second air inlet; wherein the first air inlet is adjacent to the motor, and the second air inlet is adjacent to the circuit board; the first air inlet is disposed between the air outlet and the second air inlet;
wherein the power tool further comprises a partition disposed within the housing; the partition and the housing together enclose to define a cooling cavity arranged around the motor; the cooling cavity isolates other parts of the power tool;
wherein the power tool further comprises a first heat dissipation air path that flows through the motor and a second heat dissipation air path that flows through the circuit board, formed by a rotation of the fan;
the first heat dissipation air path is formed inside the cooling cavity and between the motor and each of side walls of the cooling cavity; the second heat dissipation air path is formed between the housing and the cooling cavity.

19. The power tool according to claim 18, wherein the power tool has a lateral direction perpendicular to the axis direction of the output shaft, and the first air inlet is defined on a part of the housing facing an outer side of the motor in the lateral direction.

20. The power tool according to claim 18, wherein the first heat dissipation air path passes through the first air inlet and the motor sequentially to the air outlet, and the second heat dissipation air path passes through the second air inlet and the circuit board sequentially to the air outlet; the first heat dissipation air path and the second heat dissipation air path are independently disposed of each other.
